(19) United States
(12) Patent Application Publication
(10) Pub. No.: US 2018/0218047 A1
(43) Pub. Date: Aug. 2, 2018

(54) IN-VEHICLE INFORMATION TERMINAL AND NON-TRANSITORY COMPUTER-READABLE STORAGE MEDIUM STORING INFORMATION SEARCH PROGRAM

(71) Applicant: TOYOTA JIDOSHA KABUSHIKI KAISHA, Toyota-shi (JP)

(72) Inventor: Taiki YAMASHITA, Toyota-shi (JP)

(73) Assignee: TOYOTA JIDOSHA KABUSHIKI KAISHA, Toyota-shi (JP)

(21) Appl. No.: 15/883,683

(22) Filed: Jan. 30, 2018

(30) Foreign Application Priority Data
Feb. 1, 2017 (JP) 2017-016625

(51) Int. Cl. G06F 17/30; G10L 15/22

(52) U.S. Cl. CPC G06F 17/30507; G10L 2015/223; G06F 17/30401; G10L 15/22

(57) ABSTRACT

An in-vehicle information terminal includes a recognition processing circuitry configured to recognize an input voice and a search processing circuitry configured to perform a search for information based on a content of a voice recognized by the recognition processing circuitry. The search processing circuitry is configured to, when a speed of a vehicle is higher than or equal to a predetermined threshold, automatically start a search for information after voice input, and is configured to, when the speed of the vehicle is lower than the predetermined threshold, start a search for the information on the condition that an operation to start a search has been conducted through an input operation circuitry after voice input.

### INCORPORATION BY REFERENCE

The disclosure of Japanese Patent Application No. 2017-016625 filed on Feb. 1, 2017 including the specification, drawings and abstract is incorporated herein by reference in its entirety.

### BACKGROUND

### 1. Technical Field

The disclosure relates to an in-vehicle information terminal and a non-transitory computer-readable storage medium storing an information search program.

### SUMMARY

However, if the information terminal described in JP 2004-265217 A is mounted on a vehicle, it may be difficult for a driver to check a displayed keyword input by voice and correct the keyword depending on a traveling status of the vehicle. That is, there still remains room for improvement in achieving both the operability of driving operation of the vehicle and the operability of information search based on voice input.

The disclosure provides an in-vehicle information terminal and a non-transitory computer-readable storage medium storing an information search program, which are able to achieve both the operability of driving operation of a vehicle and the operability of information search based on voice input.

A first aspect of the disclosure provides an in-vehicle information terminal. The in-vehicle information terminal is mounted on a vehicle. The in-vehicle information terminal is configured to perform a search for information on the basis of an input voice. The in-vehicle information terminal includes a recognition processing circuitry configured to recognize an input voice and a search processing circuitry configured to perform a search for information based on a content of a voice recognized by the recognition processing circuitry. The search processing circuitry is configured to, when a speed of the vehicle is higher than or equal to a predetermined threshold, automatically start a search for the information after voice input. The search processing circuitry is configured to, when the speed of the vehicle is lower than the predetermined threshold, start a search for the information on the condition that an operation to start a search has been conducted through an input operation circuitry after voice input.

A second aspect of the disclosure provides a non-transitory computer-readable storage medium storing an information search program. The information search program causes a computer to execute a voice recognition process of recognizing a voice input through a voice input circuitry mounted on a vehicle and a search process of performing a search for information based on a content of a voice recognized through the voice recognition process. In the search process, when a speed of the vehicle is higher than or equal to a predetermined threshold, a search for the information is automatically started; whereas, when the speed of the vehicle is lower than the predetermined threshold, a search for the information is started on the condition that an operation to start a search has been conducted through an input operation circuitry after voice input.

With the above configuration, when the speed of the vehicle is relatively high, it is considered that the driver of the vehicle has no allowance for conducting an operation to start a search for information through the input operation circuitry, so a search for information based on an input voice is automatically started irrespective of whether there is an operation to start a search. On the other hand, when the speed of the vehicle is relatively low, it is considered that the driver of the vehicle has an allowance for conducting an operation to start a search for information through the input operation circuitry, so a search for information based on an input voice is started on the condition that an operation to start a search has been conducted. That is, whether to automatically start a search for information based on an input voice depends on a traveling status of the vehicle. Thus, it is possible to achieve both the operability of driving operation of the vehicle and the operability of information search based on voice input.

In the in-vehicle information terminal, the search processing circuitry may be configured to, when the speed of the vehicle is higher than or equal to the predetermined threshold, automatically start a search for the information based on a content of a voice recognized by the recognition processing circuitry on the condition that a standby time has elapsed after voice input.

With the above configuration, even when the speed of the vehicle is relatively high, a standby time for allowing the driver to check the content of an input voice is ensured at the time before a search for information is automatically started. Thus, it is possible to reduce a situation that a search for information is started on the basis of the content of a voice that is not in consonance with driver's intention.

In the in-vehicle information terminal, the search processing circuitry may be configured to, when the speed of the vehicle has changed from a value lower than the predetermined threshold to a value higher than or equal to the predetermined threshold before a standby time elapses since voice input, automatically start a search for the information at the time when a standby time has elapsed since the speed of the vehicle has changed.

When the traveling status of the vehicle significantly changes with the tendency that the speed of the vehicle increases before a standby time elapses since voice input, for example, when the vehicle starts moving at an intersection, it is considered that the driver loses an allowance for conducting an operation to start a search for information on the way. For this reason, in the above configuration, in such a case, while a standby time for allowing the driver to check the content of an input voice is ensured from the time when the driver loses an allowance, a search for information based on an input voice is started irrespective of whether there is an operation to start a search through the input operation circuitry. Thus, a change in the traveling status of the vehicle after voice input is considered, while it is possible to suitably achieve both the operability of driving operation of the vehicle and the operability of information search based on voice input.

In the in-vehicle information terminal, the search processing circuitry may be configured to, when the speed of the vehicle is lower than the predetermined threshold and when no operation to start a search has been conducted through the input operation circuitry before a standby time elapses since voice input, discard data of a voice recognized by the recognition processing circuitry.

With the above configuration, although the driver of the vehicle has an allowance for conducting an operation to start a search for information through the input operation circuitry, there is no declaration of intention from the driver even when a certain time has elapsed from voice input, data of the recognized voice is discarded, and an opportunity to input a new voice is ensured. Thus, it is possible to further improve the operability of information search based on a voice input in consonance with driver's intention.

In the in-vehicle information terminal, the search processing circuitry may be configured to, when the speed of the vehicle has changed from a value higher than or equal to the predetermined threshold to a value lower than the predetermined threshold before a lapse of the standby time after voice input and when no operation to start a search has been conducted through the input operation circuitry before a standby time elapses since the speed of the vehicle has changed, discard data of a voice recognized by the recognition processing circuitry.

When the traveling status of the vehicle significantly changes with the tendency that the speed of the vehicle decreases before a standby time elapses since voice input, for example, when the vehicle stops at an intersection, it is considered that the driver gains an allowance for conducting an operation to start a search for information halfway. For this reason, in the above configuration, when there is no declaration of intention from the driver even when a certain time has elapsed from when the driver ensures an allowance, data of the recognized voice is discarded, and an opportunity to input a new voice is ensured. Thus, it is possible to further improve the operability of information search based on voice input in consonance with driver's intention while considering a change in the traveling status of the vehicle after voice input.

In the in-vehicle information terminal, the predetermined threshold may be a speed of the vehicle, which is a determination criterion as to whether a traveling status of the vehicle is a traveling state or a stopped state. Generally, the degree of allowance to which the driver of the vehicle conducts an operation to start a search for information through the input operation circuitry significantly varies depending on whether the traveling status of the vehicle is a traveling state or a stopped state. In this respect, in the above configuration, whether to automatically start a search for information is switched in response to whether the traveling status of the vehicle is a traveling state or a stopped state. Thus, it is possible to further suitably achieve both the operability of driving operation of the vehicle and the operability of information search based on voice input.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram that shows the schematic configuration of an in-vehicle information terminal according to an embodiment;

FIG. 2 is a schematic view for illustrating the process of a search for information;

FIG. 3 is a flowchart that shows the detailed procedure of an information search process that is executed by the in-vehicle information terminal according to the embodiment; and

FIG. 4 is a schematic view that shows a correspondence relation between a traveling status of a vehicle and timing at which a search for information is started.

### DETAILED DESCRIPTION OF EMBODIMENTS

An in-vehicle information terminal according to an embodiment performs a search for information on the basis of a voice input from a driver of a vehicle. In this in-vehicle information terminal, a traveling status of the vehicle is determined on the basis of the speed of the vehicle, and, when it is determined that the vehicle is traveling, a search for information is automatically started after voice input. On the other hand, when the in-vehicle information terminal determines that the vehicle is stopped, the in-vehicle information terminal starts a search for information on the condition that the driver of the vehicle has conducted an operation to start a search after voice input. When the in-vehicle information terminal has started a search for information, the in-vehicle information terminal generates a keyword that is a search target on the basis of the voice input from the driver of the vehicle, and transmits the generated keyword to an external server. After that, when the in-vehicle information terminal has received search result information from the external server, the in-vehicle information terminal outputs the received search result information to a display device and shows the search result information to the driver of the vehicle.

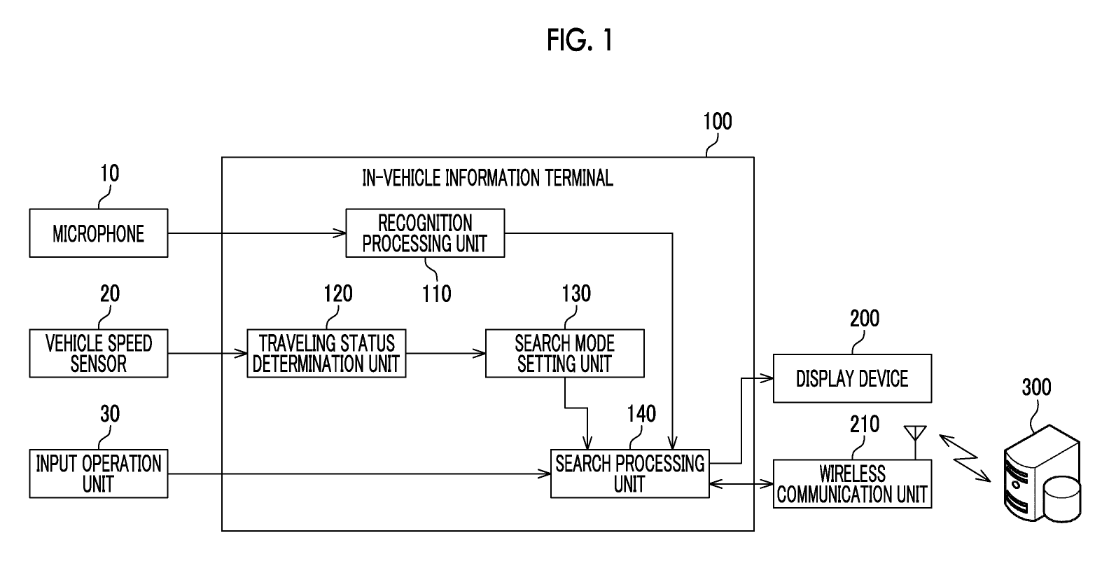

Specifically, as shown in FIG. 1, a vehicle on which the in-vehicle information terminal 100 according to the present embodiment is mounted includes a microphone 10, a vehicle speed sensor 20, an input operation unit 30, a display device 200 and a wireless communication unit 210. These components are electrically connected to the in-vehicle information terminal 100.

The in-vehicle information terminal 100 includes a recognition processing unit 110. A signal of a voice emitted by the driver through the microphone 10 provided in the vehicle is input to the recognition processing unit 110. The recognition processing unit 110, for example, divides a voice that is input from the microphone 10 into a plurality of sections each having a certain time width, and compares a feature vector of a voice included in each divided section with a feature vector of a voice pattern prepared in advance by dynamic programming (DP) matching, or the like. The recognition processing unit 110 recognizes a voice pattern of which the feature vector has the highest similarity as the content of the voice emitted in that section, and converts the recognized content of the voice to text data. The recognition processing unit 110 outputs the converted text data to a search processing unit 140.

The in-vehicle information terminal 100 includes a traveling status determination unit 120. The traveling status determination unit 120 determines the traveling status of the vehicle on the basis of the speed of the vehicle, which is input from the vehicle speed sensor 20. The traveling status determination unit 120 determines that the vehicle is traveling when the speed of the vehicle is higher than or equal to a predetermined threshold, and determines that the vehicle is stopped when the speed of the vehicle is lower than the predetermined threshold. That is, the predetermined threshold is set as the speed of the vehicle, which is a determination criterion as to whether the traveling status of the vehicle is a traveling state or a stopped state. The traveling status determination unit 120 outputs a determined result regarding the traveling status of the vehicle to a search mode setting unit 130.

The search mode setting unit 130 sets an information search mode on the basis of the traveling status of the vehicle, which is input from the traveling status determination unit 120. The information search mode is a mode in which the search processing unit 140 performs a search for information. More specifically, the search mode setting unit 130 sets an automatic search mode as the information search mode when the vehicle is traveling. In the automatic search mode, a search for information is automatically started after voice input. The search mode setting unit 130 sets a manual search mode as the information search mode when the vehicle is stopped. In the manual search mode, a search for information is started on the condition that the driver of the vehicle has conducted an operation to start a search after voice input. The search mode setting unit 130 outputs the set information search mode to the search processing unit 140.

The search processing unit 140 performs a search for information by using text data, which is input from the recognition processing unit 110, as a search keyword on the basis of the information search mode that is input from the search mode setting unit 130. Even when the information search mode is any of the automatic search mode and the manual search mode, the search processing unit 140 outputs text data, which is input from the recognition processing unit 110, to the display device 200 and displays the text data.

While the automatic search mode is being executed, the search processing unit 140 waits from when text data has been input from the recognition processing unit 110 to when the driver of the vehicle conducts an operation to start a search for information through the input operation unit 30 or until a first standby time elapses. During times before the first standby time elapses, the search processing unit 140 outputs a browser page for performing a search for information to the display device 200 by launching a web browser and displays the browser page on the display device 200. The search processing unit 140 receives an operation to correct text data through the input operation unit 30 while displaying the text data, input from the recognition processing unit 110, in a search box that shows a search target on the browser page displayed on the display device 200. When the operation to correct the text data has been conducted, the search processing unit 140 outputs the corrected text data to the display device 200 and displays the corrected text data on the display device 200. The operation to correct text data may be conducted in such a manner that the driver manually selects a correcting portion of the text data through the input operation unit 30. Alternatively, the operation to correct text data may be conducted in such a manner that the driver conducts an operation to start correction through the input operation unit 30 and then re-inputs a voice through the microphone 10.

When an operation to start a search for information has been conducted before the first standby time elapses, the search processing unit 140 starts a search for information at the time when the operation to start a search for information has been conducted. On the other hand, even when no operation to start a search for information has been conducted before the first standby time elapses, the search processing unit 140 starts a search for information at the time when the first standby time has elapsed since the text data has been input from the recognition processing unit 110.

While the manual search mode is being executed, the search processing unit 140 waits from when text data has been input from the recognition processing unit 110 to when the driver of the vehicle conducts an operation to start a search for information through the input operation unit 30 or until a second standby time elapses. In the present embodiment, the second standby time is set so as to be longer than the first standby time. During times until the second standby time elapses, the search processing unit 140 receives an operation to correct the text data through the input operation unit 30 while displaying the text data on the display device 200. When the operation to correct the text data has been conducted, the search processing unit 140 outputs the corrected text data to the display device 200 and displays the corrected text data on the display device 200. When an operation to start a search for information has been conducted before the second standby time elapses, the search processing unit 140 starts a search for information at the time when the operation to start a search for information has been conducted. On the other hand, even when no operation to start a search for information has been conducted before the second standby time elapses, the search processing unit 140 does not start a search for information. The search processing unit 140 discards the text data input from the recognition processing unit 110 and then receives input of new text data from the recognition processing unit 110.

While the automatic search mode is being executed, when the vehicle has stopped before the first standby time elapses, a change in the traveling status of the vehicle is input from the traveling status determination unit 120 to the search mode setting unit 130. As a result, the search mode setting unit 130 switches the setting of the information search mode from the automatic search mode to the manual search mode. When the information search mode that is input from the search mode setting unit 130 has been switched, the search processing unit 140 resets the count of the first standby time to zero and starts the count of the second standby time. When the operation to start a search for information has been conducted before the second standby time elapses, the search processing unit 140 starts a search for information at the time when the operation to start a search for information has been conducted. On the other hand, when no operation to start a search for information has been conducted before the second standby time elapses, the search processing unit 140 does not start a search for information. In this case, the search processing unit 140 discards the text data input from the recognition processing unit 110 and then receives input of new text data from the recognition processing unit 110.

While the manual search mode is being executed, when the vehicle starts traveling before the second standby time elapses, a change in the traveling status of the vehicle is input from the traveling status determination unit 120 to the search mode setting unit 130. As a result, the search mode setting unit 130 switches the setting of the information search mode from the manual search mode to the automatic search mode. When the information search mode that is input from the search mode setting unit 130 has been switched, the search processing unit 140 resets the count of the second standby time to zero and starts the count of the first standby time. When an operation to start a search for information has been conducted before the first standby time elapses, the search processing unit 140 starts a search for information at the time when the operation to start a search for information has been conducted. On the other hand, even when no operation to start a search for information has been conducted before the first standby time elapses, the search processing unit 140 starts a search for information at the time when the first standby time has elapsed.

After that, when the search processing unit 140 starts a search for information, the search processing unit 140 transmits the text data input from the recognition processing unit 110 to an external server 300 through the wireless communication unit 210 as a search keyword. On the other hand, when the external server 300 has received a search keyword from the search processing unit 140, the external server 300 causes a search engine to operate by using the received keyword as an input and acquires search result information. The external server 300 transmits the search result acquired from the search engine to the search processing unit 140 via the wireless communication unit 210. The search processing unit 140 outputs the search result information received from the external server 300 to the display device 200 and displays the search result information on the display device 200.

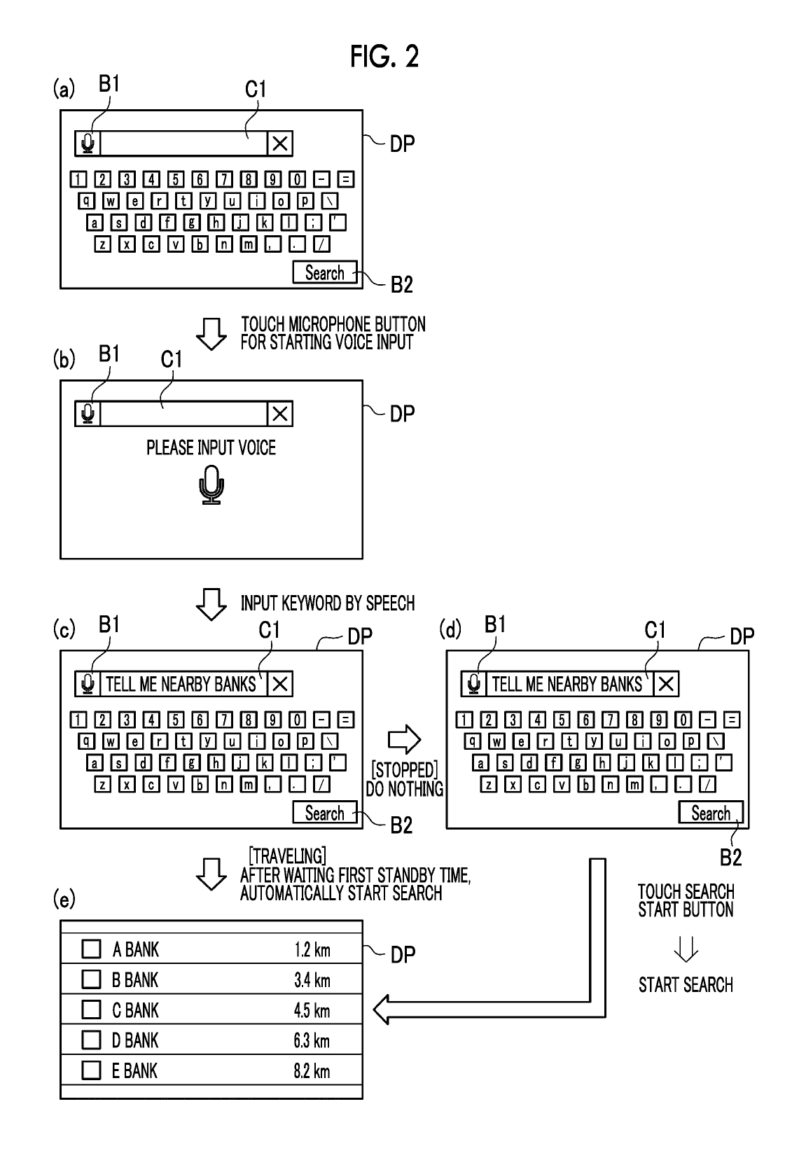

Next, an example of a view to be displayed on the display device 200 in process in which the in-vehicle information terminal 100 performs a search for information on the basis of a voice input from the driver will be described with reference to FIG. 2. In this example, the display device 200 is constituted of a touch panel, and the display screen of the display device 200 functions as the input operation unit 30. When the driver touches operation buttons displayed on the display device 200 with a finger, various operations are performed.

As shown in (a) of FIG. 2, the in-vehicle information terminal 100 initially outputs a browser page DP for performing a search for information to the display device 200 and displays the browser page DP on the display device 200. In the example shown in the drawing, an input start button B1 that is used at the time of starting voice input is displayed side by side to a search box C1 at the upper left position on the browser page DP.

As shown in (b) of FIG. 2, as the input start button B1 is touched by the driver, the in-vehicle information terminal 100 shifts the browser page DP to a page that prompts the driver to input a voice.

Subsequently, as shown in (c) of FIG. 2, as the driver inputs a keyword by speech, the in-vehicle information terminal 100 displays the input keyword in the search box C1 on the browser page DP. In the example shown in the drawing, the keyword that indicates an inquiry about banks around the traveling location of the vehicle is displayed in the search box Cl1 on the browser page DP.

In this case, when the vehicle is traveling, the in-vehicle information terminal 100 waits until the first standby time elapses since the driver has input the keyword by speech. During then, the in-vehicle information terminal 100 continuously displays the keyword that the driver has input by speech in the search box C1 on the browser page DP. The in-vehicle information terminal 100 starts a search for information at the time when the first standby time has elapsed since the driver has input the keyword by speech.

On the other hand, while the vehicle is stopped, the in-vehicle information terminal 100 waits until the second standby time elapses since the driver has input the keyword by speech. During then, as shown in (d) of FIG. 2, the in-vehicle information terminal 100 continuously displays the keyword that the driver has input by speech in the search box C1 on the browser page DP. As a search start button B2 that is used at the time of starting a search for information is touched by the driver, the in-vehicle information terminal 100 starts a search for information. In the example shown in the drawing, the search start button B2 that is used at the time of starting a search for information is displayed at the lower right position on the browser page DP.

As shown in (e) of FIG. 2, as the in-vehicle information terminal 100 acquires search result information from the external server 300, the in-vehicle information terminal 100 outputs the acquired search result information to the display device 200 and displays the acquired search result information on the display device 200. In the example shown in the drawing, the in-vehicle information terminal 100 sequentially arranges banks in ascending order of distance from the traveling location of the vehicle and lists the banks together with distances from the traveling location of the vehicle.

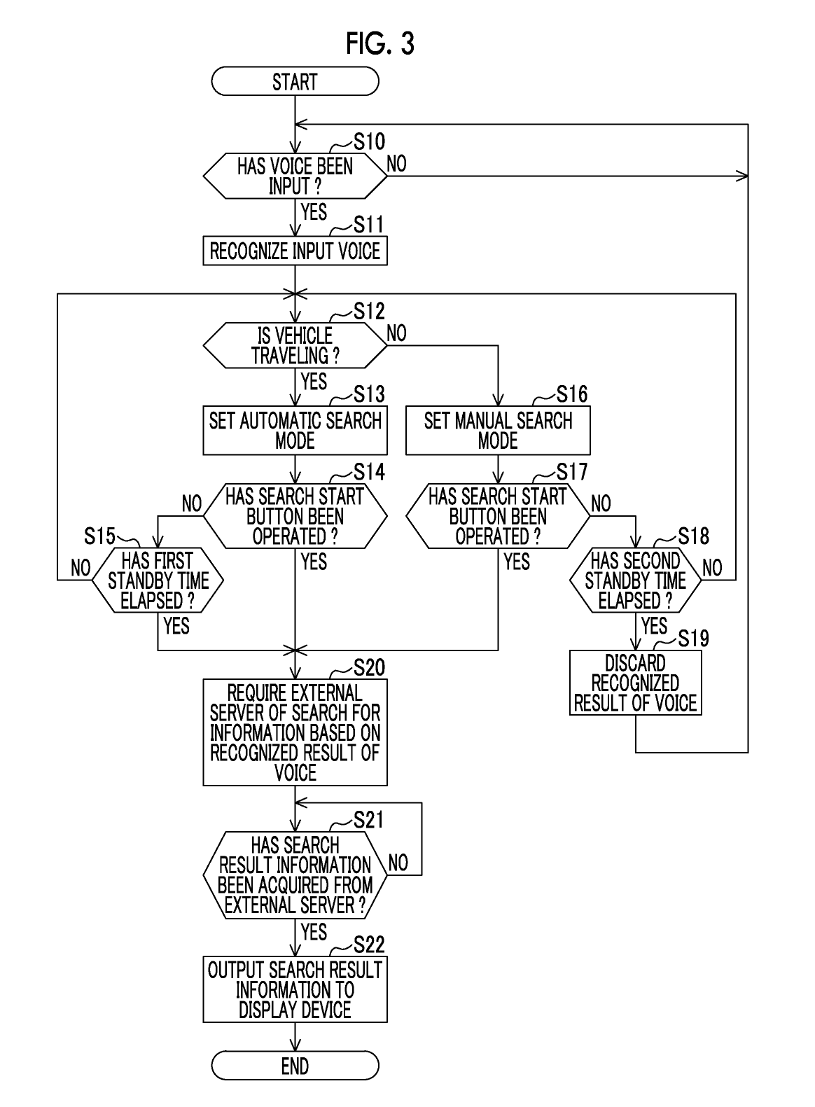

Next, a specific procedure of an information search process that the in-vehicle information terminal 100 according to the present embodiment executes on the basis of an information search program will be described. The in-vehicle information terminal 100 executes the information search process shown in FIG. 3 at predetermined intervals.

Initially, as shown in FIG. 3, the in-vehicle information terminal 100 waits until a voice is input from the driver of the vehicle through the microphone 10 (step S10). When a voice has been input (YES in step S10), the in-vehicle information terminal 100 recognizes the input voice through the recognition processing unit 110 and converts the input voice to text data (step S11).

Subsequently, the in-vehicle information terminal 100 determines through the traveling status determination unit 120 whether the vehicle is traveling on the basis of whether the speed of the vehicle, acquired from the vehicle speed sensor 20, is higher than or equal to a predetermined threshold (step S12).

When the in-vehicle information terminal 100 determines that the vehicle is traveling (YES in step S12), the in-vehicle information terminal 100 sets the automatic search mode as the information search mode through the search mode setting unit 130.

Subsequently, the in-vehicle information terminal 100 determines through the search processing unit 140 whether the search start button B2 has been operated (step S14). When the search start button B2 has not been operated (NO in step S14), and when the first standby time has not elapsed yet (NO in step S15), the in-vehicle information terminal 100 returns the process to step S12.

On the other hand, when the search start button B2 has been operated before the first standby time elapses (YES in step S14), the in-vehicle information terminal 100 proceeds with the process to step S20. When the first standby time has elapsed without operating the search start button B2 (YES in step S15), the in-vehicle information terminal 100 proceeds with the process to step S20.

When the in-vehicle information terminal 100 determines in step S12 that the vehicle is stopped (NO in step S12), the in-vehicle information terminal 100 sets the manual search mode as the information search mode through the search mode setting unit 130.

Subsequently, the in-vehicle information terminal 100 determines through the search processing unit 140 whether the search start button B2 has been operated (step S17). When the search start button B2 has not been operated (NO in step S17), and when the second standby time has not elapsed yet (NO in step S18), the in-vehicle information terminal 100 returns the process to step S12.

On the other hand, when the search start button B2 has been operated before the second standby time elapses (YES in step S17), the in-vehicle information terminal 100 proceeds with the process to step S20. When the second standby time has elapsed without operating the search start button B2 (YES in step S18), the in-vehicle information terminal 100 discards the text data of the voice recognized in step S11 (step S19). The in-vehicle information terminal 100 returns the process to step S10, and waits for input of a new voice through the microphone 10.

Subsequently, in step S20, the in-vehicle information terminal 100 requires the external server 300 of a search for information through the search processing unit 140 by using the text data of the voice recognized in step S11 as a search keyword (step S20).

After that, the in-vehicle information terminal 100 waits until the in-vehicle information terminal 100 acquires search result information from the external server 300 through the search processing unit 140 (step S21). When the in-vehicle information terminal 100 has acquired search result information from the external server 300 (YES in step S21), the in-vehicle information terminal 100 outputs the acquired search result information from the search processing unit 140 to the display device 200 and displays the acquired search result information on the display device 200 (step S22), and then ends the information search process shown in FIG. 3.

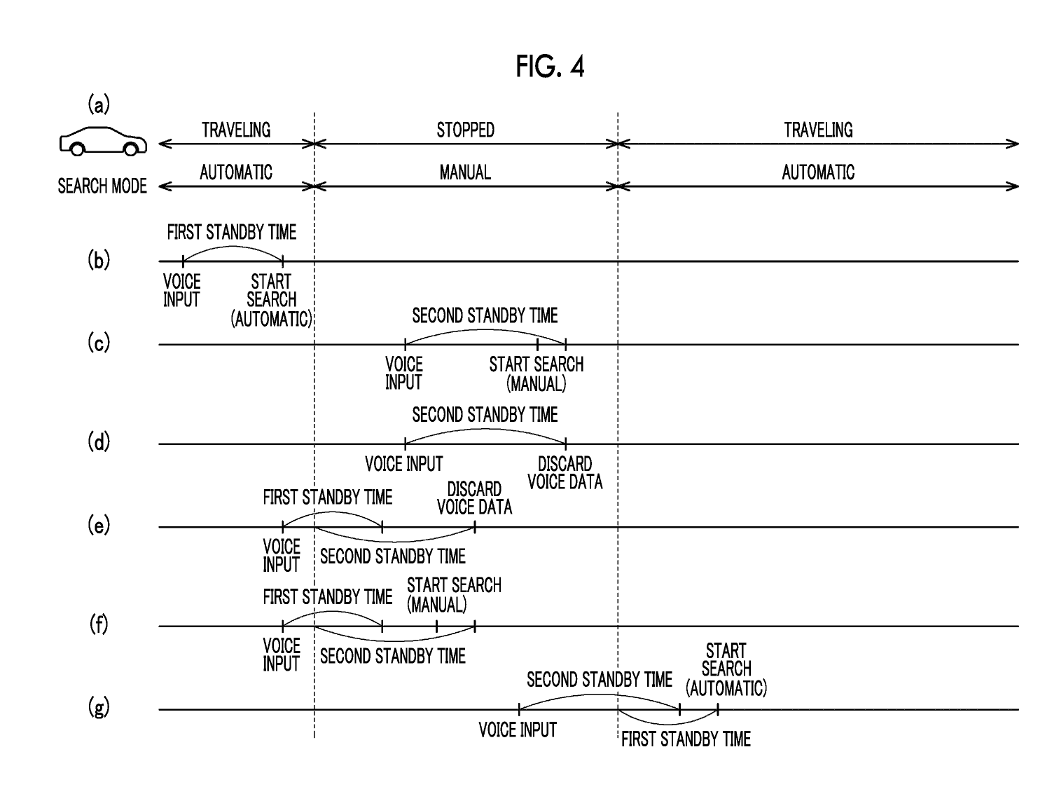

Next, the operation of the in-vehicle information terminal 100 according to the present embodiment will be described. As shown in (a) of FIG. 4, when the vehicle is traveling, the automatic search mode is set as the information search mode; whereas, when the vehicle is stopped, the manual search mode is set as the information search mode.

As shown in (b) of FIG. 4, when a voice has been input from the driver while the vehicle is traveling, even when no operation to start a search for information has been conducted, a search for information is started at the time when the first standby time has elapsed since voice input. That is, when the vehicle is traveling, a search for information based on the voice input from the driver is automatically started irrespective of whether there is an operation to start a search for information. This is because, even when no operation to start a search for information has been conducted before the first standby time elapses since voice input, the driver just has no allowance to perform the operation and the content of the input voice can be in consonance with driver's intention.

Particularly, in the present embodiment, when a voice from the driver has been input while the vehicle is traveling, a search for information is not immediately started but a search for information is waited until the first standby time elapses. That is, even when the vehicle is traveling, a standby time for allowing the driver to check the content of an input voice is ensured before a search for information is automatically started. When the content of an input voice is not in consonance with driver's intention, the driver is allowed to correct the content of the voice as needed.

As shown in (c) of FIG. 4, when a voice from the driver has been input while the vehicle is stopped, and when an operation to start a search for information has been conducted before the second standby time elapses since voice input, a search for information is started. On the other hand, as shown in (d) of FIG. 4, when no operation to start a search for information has been conducted before the second standby time elapses since voice input, a search for information is not performed. That is, while the vehicle is stopped and when the driver of the vehicle is considered to have an allowance, a search for information based on the voice input from the driver is started only when an operation to start a search for information has been conducted. This is because, when the driver of the vehicle conducts no operation to start a search for information before the second standby time elapses in a state where the driver has an allowance, it is highly likely that the content of an input voice is not in consonance with driver's intention.

As shown in (e) and (f) of FIG. 4, when a voice from the driver has been input while the vehicle is traveling but the vehicle has stopped before the first standby time elapses, for example, when the vehicle stops at an intersection, the count of the second standby time is started at the time when the vehicle has stopped. As shown in (e) of FIG. 4, when no operation to start a search for information has been conducted before the second standby time elapses, a search for information is not performed. On the other hand, as shown in (f) of FIG. 4, when an operation to start a search for information has been conducted before the second standby time elapses, a search for information is started. That is, when the traveling status of the vehicle shifts from a traveling state to a stopped state and it is considered that the driver of the vehicle has an allowance, a search for information based on the voice input from the driver is started only when there is an operation to start a search for information. This is because, in a state where the driver has an allowance, it is highly likely that whether there is an operation to start a search for information before the second standby time elapses exactly reflects driver's intention.

As shown in (g) of FIG. 4, when a voice from the driver has been input while the vehicle is stopped but the vehicle starts traveling before the second standby time elapses, for example, when the vehicle starts moving at an intersection, the count of the first standby time is started at the time when the vehicle has started traveling. Even when no operation to start a search for information has been conducted before the first standby time elapses, a search for information based on the voice input from the driver is automatically started. That is, when the traveling status of the vehicle shifts from a stopped state to a traveling state and it is considered that the driver of the vehicle has no allowance, a search for information based on the voice input from the driver is started irrespective of whether there is an operation to start a search for information. This is because, in a state where the driver has no allowance, it is likely that whether there is an operation to start a search for information before the first standby time elapses does not exactly reflect driver's intention.

As described above, according to the above-described embodiment, the following advantageous effects are obtained.

(1) Whether to automatically start a search for information based on an input voice in response to the traveling status of the vehicle is switched. Thus, it is possible to achieve both the operability of driving operation of the vehicle and the operability of information search based on voice input.

(2) Even when the speed of the vehicle is relatively high, a standby time for allowing the driver to check the content of an input voice is ensured before a search for information is automatically started. Thus, it is possible to reduce a situation that a search for information is started on the basis of the content of a voice that is not in consonance with driver's intention.

(3) When the traveling status of the vehicle significantly changes with the tendency that the speed of the vehicle increases until the standby time elapses since voice input, a standby time for allowing the driver to check the content of the input voice is ensured, while a search for information based on the input voice is started irrespective of whether there is an operation to start a search for information. Thus, a change in the traveling status of the vehicle after voice input is considered, while it is possible to suitably achieve both the operability of driving operation of the vehicle and the operability of information search based on voice input.

(4) Although the driver of the vehicle has an allowance to conduct an operation to start a search for information, when the driver does not express any declaration of intention even when a certain time has elapsed since voice input, data of the recognized voice is discarded, and an opportunity to input a new voice is ensured. Thus, it is possible to further improve the operability of information search based on voice input in consonance with driver's intention.

(5) When the traveling status of the vehicle significantly changes with the tendency that the speed of the vehicle decreases until the first standby time elapses since voice input, and when there is no declaration of intention from the driver even when a certain time has elapsed since the traveling status of the vehicle has changed, data of the recognized voice is discarded, and an opportunity to input a new voice is ensured. Thus, it is possible to further improve the operability of information search based on voice input in consonance with driver's intention while considering a change in the traveling status of the vehicle after voice input.

(6) Whether to automatically start a search for information is switched in response to whether the traveling status of the vehicle is a traveling state or a stopped state. Thus, it is possible to further suitably achieve both the operability of driving operation of the vehicle and the operability of information search based on voice input.

The above-described embodiment may be implemented in the following modes.

In the above-described embodiment, a voice is input from the driver while the vehicle is traveling, and, when the vehicle has stopped before the first standby time elapses, the count of the second standby time is started at the time when the vehicle has stopped. However, a standby time to start counting at the time when the vehicle has stopped is not necessarily the same as a standby time in the manual search mode. The standby time to start counting at the time when the vehicle has stopped may be longer than the standby time in the manual search mode or may be shorter than the standby time in the manual search mode. The count of the first standby time may be not reset to zero at the time when the vehicle has stopped but text data of an input voice may be discarded at the time when the first standby time has elapsed thereafter. Text data of the input voice may be immediately discarded at the time when the vehicle has stopped.

In the above-described embodiment, a voice from the driver is input while the vehicle is stopped, but, when the vehicle has started traveling before the second standby time elapses, the count of the first standby time is started at the time when the vehicle has started traveling. However, a standby time to start counting at the time when the vehicle has started traveling is not necessarily the same as a standby time in the automatic search mode. The standby time to start counting at the time when the vehicle has started traveling may be longer than the standby time in the automatic search mode or may be shorter than the standby time in the automatic search mode. The count of the second standby time may be not reset to zero at the time when the vehicle has started traveling but a search for information may be automatically started at the time when the second standby time has elapsed thereafter. An information search may be immediately started at the time when the vehicle has started traveling.

In the above-described embodiment, the second standby time is described by taking the case where the second standby time is set so as to be longer than the first standby time as an example. However, the second standby time may be set so as to be shorter than the first standby time, or these standby times may be the same.

In the above-described embodiment, when a voice from the driver has been input while the vehicle is stopped, and when no operation to start a search for information has been conducted before the second standby time elapses since voice input, text data of the input voice is discarded. Instead, when a voice from the driver has been input while the vehicle is stopped, a search for information may be waited until an operation to start a search for information is conducted by the driver irrespective of a time elapsed since voice input.

In the above-described embodiment, when a voice from the driver has been input while the vehicle is traveling, even when no operation to start a search for information has been conducted, a search for information is automatically started at the time when the first standby time has elapsed since voice input. Instead, when a voice from the driver has been input while the vehicle is traveling, a search for information may be automatically started just after the voice has been input without providing a standby time for conducting an operation to start a search for information.

In the above-described embodiment, the case where the speed of the vehicle, which is a determination criterion as to whether the vehicle is traveling or stopped, is used as the predetermined threshold is described as an example. However, as long as the speed of the vehicle is an index of the degree of driver's allowance, the predetermined threshold may be the speed of the vehicle at a boundary at the time when the speed of the vehicle is divided into a low speed range and a high speed range.

In the above-described embodiment, as an operation to start a search for information, the case where the search start button B2 is touched on the display page of the display device 200 is described as an example. However, the operation to start a search for information may be not necessarily an operation attended with a physical contact. The operation to start a search for information may be conducted by, for example, detecting movement of driver's line of sight through image recognition or detecting a voice input from the driver through voice recognition.

What is claimed is:

1. An in-vehicle information terminal mounted on a vehicle, the in-vehicle information terminal being configured to perform a search for information on the basis of an input voice, the in-vehicle information terminal comprising:
a recognition processing circuitry configured to recognize an input voice; and
a search processing circuitry configured to perform a search for information based on a content of a voice recognized by the recognition processing circuitry, the search processing circuitry is configured to, when a speed of the vehicle is higher than or equal to a predetermined threshold, automatically start a search for the information after voice input, and is configured to, when the speed of the vehicle is lower than the predetermined threshold, start a search for the information on the condition that an operation to start a search has been conducted through an input operation circuitry after voice input.

2. The in-vehicle information terminal according to claim 1, wherein
the search processing circuitry is configured to, when the speed of the vehicle is higher than or equal to the predetermined threshold, automatically start a search for the information based on a content of a voice recognized by the recognition processing circuitry on the condition that a standby time has elapsed after voice input.

3. The in-vehicle information terminal according to claim 1, wherein
the search processing circuitry is configured to, when the speed of the vehicle has changed from a value lower than the predetermined threshold to a value higher than or equal to the predetermined threshold before a standby time elapses since voice input, automatically start a search for the information at the time when a standby time has elapsed since the speed of the vehicle has changed.

4. The in-vehicle information terminal according to claim 1, wherein
the search processing circuitry is configured to, when the speed of the vehicle is lower than the predetermined threshold and when no operation to start a search has been conducted through the input operation circuitry before a standby time elapses since voice input, discard data of a voice recognized by the recognition processing circuitry.

5. The in-vehicle information terminal according to claim 1, wherein
the search processing circuitry is configured to, when the speed of the vehicle is lower than the predetermined threshold, start a search for the information based on a content of a voice recognized by the recognition processing circuitry on the condition that an operation to start a search has been conducted through the input operation circuitry before a standby time elapses since voice input.

6. The in-vehicle information terminal according to claim 1, wherein
the search processing circuitry is configured to, when the speed of the vehicle has changed from a value higher than or equal to the predetermined threshold to a value lower than the predetermined threshold before a standby time elapses since voice input and when no operation to start a search has been conducted through the input operation circuitry before a standby time elapses since the speed of the vehicle has changed, discard data of a voice recognized by the recognition processing circuitry.

7. The in-vehicle information terminal according to claim 1, wherein
the search processing circuitry is configured to, when the speed of the vehicle has changed from a value higher than or equal to the predetermined threshold to a value lower than the predetermined threshold before a standby time elapses since voice input, start a search for the information based on a content of a voice recognized by the recognition processing circuitry on the condition that an operation to start a search has been conducted through the input operation circuitry before a standby time elapses since the speed of the vehicle has changed.

8. The in-vehicle information terminal according to claim 1, wherein
the predetermined threshold is a speed of the vehicle, which is a determination criterion as to whether a traveling status of the vehicle is a traveling state or a stopped state.

9. A non-transitory computer-readable storage medium storing an information search program, the information search program causing a computer to execute:
a voice recognition process of recognizing a voice input through a voice input circuitry mounted on a vehicle; and
a search process of performing a search for information based on a content of a voice recognized through the voice recognition process, wherein
in the search process, when a speed of the vehicle is higher than or equal to a predetermined threshold, a search for the information is automatically started; whereas, when the speed of the vehicle is lower than the predetermined threshold, a search for the information is started on the condition that an operation to start a search has been conducted through an input operation circuitry after voice input.
